(19) United States
(12) Patent Application Publication
(10) Pub. No.: US 2025/0294420 A1
(43) Pub. Date: Sep. 18, 2025

(54) MOBILITY MANAGEMENT AND ACCESS CONTROL METHODS

(71) Applicant: ZTE Corporation, Shenzhen (CN)

(72) Inventors: Zhihong QIU, Shenzhen (CN); Yuan GAO, Shenzhen (CN); Mengjie ZHANG, Shenzhen (CN)

(21) Appl. No.: 19/223,760

(22) Filed: May 30, 2025

Related U.S. Application Data
(63) Continuation of application No. PCT/CN2023/076661, filed on Feb. 17, 2023.

(51) Int. Cl. H04W 36/08; H04W 36/24; H04W 68/02; H04W 74/0833; H04W 76/20

(52) U.S. Cl. CPC H04W 36/08; H04W 36/249; H04W 68/02; H04W 74/0833; H04W 76/20

(57) ABSTRACT

This document discloses methods, apparatus, and systems that conduct mobility management and access control in wireless communication systems. In one example aspect, a method for wireless communication includes receiving, by a wireless device, from a network device, a configuration information comprising handover configuration information; and initiating, by the wireless device, a handover process based on the configuration information.

### CROSS REFERENCE TO RELATED APPLICATIONS

This patent document is a continuation of and claims benefit of priority to International Patent Application No. PCT/CN2023/076661, filed on Feb. 17, 2023. The entire content of the before-mentioned patent application is incorporated by reference as part of the disclosure of this application.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, related to mobility management and access control in a wireless communication network.

In one example aspect, a wireless communication method is disclosed. The method includes receiving, by a wireless device, from a network device, a configuration information comprising handover configuration information; and initiating, by the wireless device, a handover process based on the configuration information.

In another example aspect, another wireless communication method is disclosed. The method includes transmitting, by a network device a configuration information comprising handover configuration information related to a handover process to a wireless device.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIG. 1 shows an example diagram of overall illustration of an Non-Terrestrial Network (NTN).

FIG. 2A shows an example diagram indicating Contention-based Random Access

(CBRA) with a 4-step RA type.

FIG. 2B shows an example diagram indicating CBRA with a 2-step RA type.

FIG. 2C shows an example diagram indicating CFRA with a 4-step RA type.

FIG. 2D shows an example diagram indicating Contention Free Random Access

(CFRA) with a 2-step RA type.

FIG. 3 shows an example diagram indicating fallback for CBRA with a 2-step RA

type.

FIG. 4 shows an example diagram of a user equipment (UE) capability transfer.

FIG. 5 shows an example diagram of the Timing Advance Report MAC Control

Element (CE).

FIGS. 6-7 show examples of signaling flowcharts for network (NW)-verified UE location purposes.

FIG. 8 shows an example of a block diagram of a hardware platform that may be a part of a network device or a communication device in accordance with some embodiments of the present document.

FIG. 9 shows an example of network communication, including a network device (a Base Station) and wireless device based on some implementations of the disclosed technology.

FIGS. 10-11 are flowcharts representation of methods for wireless communication in accordance with one or more embodiments of the present technology.

### DETAILED DESCRIPTION

Section headings are used in the present document to facilitate understanding and do not limit the scope of the disclosed technology to particular sections. Furthermore, certain terminology referring to 5G and Third Generation Partnership Project (3GPP) protocols is used as an illustrative example, and the disclosed techniques are applicable to other wireless protocols also.

Various example embodiments of the present solution are described in detail below with reference to the following figures or drawings. The drawings are provided for purposes of illustration only and merely depict exemplary embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale. It should be noted, in the disclosure of this patent application, a network node can be at least one of a Base Station (BS) (e.g., gNB or ng-eNB), a component of BS (e.g., CU or DU), a functional entity that hosted by BS (e.g., OAM), a core network (CN), a component of CN, a functional entity that hosted by CN (e.g., location management function (LMF)).

Handover is an essential feature of connected mode mobility management. Since the satellite movement is predictable, with the movement of satellites, a large amount of UEs may be handover to the same target cell simultaneously. In this situation, UE might also initiate Random Access Channel (RACH) to target cells to obtain uplink synchronization, leading to significant RACH contention and extra access delay at UE's side. Multiple UEs initiating RACH simultaneously may increase the conflict rate and decrease the success opportunity for each UE.

Handover disclosed in this disclosure can refer to, but is not limited to, conventional HO, conditional HO, Dual Active Protocol Stack (DAPS) HO, RACH-less HO or other handover types that may be supported for communication.

Current Non-Terrestrial Network (NTN) is based on the premise that the transmission delay between UE and satellites can be precompensated by a user equipment (UE) and/or a Network (NW). In case the service link is precompensated by UE, UE can report its location to NW. When NW is aware of UE's location NW can derive the service link delay of UE and adjust the scheduling strategies to fulfil service requirements as well as obey the regulation policy of different countries or areas. But UE might report fake locations, which might mislead NW. Therefore, methods can be defined to assist NW in knowing whether UE reported location is accurate or not. NW can based on the verified outcome to, manage UE's access to NW. For example, NW can decide to release UE, or reject UE's connection request.

To assist mobility parameters adjustment, e.g., selecting the proper target cell for handover or adjusting cell reselection priorities, a UE can be configured to perform measurements on neighbouring cells and/or frequencies. However, since the NTN coverage (e.g., coverage provided by satellite) can be significantly larger than a Terrestrial Network (TN), there could be an area where only NTN coverage is available, and no TN coverage is available. In such cases, performing measurements on TN frequency when there is no TN coverage is a waste of power. One method to help UE relax or not perform measurement on TN frequency in such scenarios is to provide UE with information that can be used to derive TN coverage. However, considering there could be different NTN deployments and uneven TN coverage distribution, using one fixed granularity to provide the TN coverage might be inefficient and requires more signalling overhead. For example, as for LEO, the typical footprint size could be a diameter from 20-1000 km, while for GEO, the footprint size diameter can range from 200-3500 km. Since GEO coverage could be hundreds of times of LEO coverage, it would take multiple times of signalling overhead to provide TN coverage if the same granularity is used for providing TN coverage information. But a larger granularity that is appropriate for GEO coverage level might not fulfil the accuracy requirement for LEO. To save signalling overhead and provide UE with information with sufficient accuracy, methods to provide TN coverage with configurable granularity are introduced.

This patent document provides methods and procedures for mobility management and access control to solve the above problems, and others.

The first embodiment proposes methods and apparatus related to configuration information transmitted to UE to introduce a randomly generated time delay to increase the success rate of UE's access procedure. The proposed methods are beneficial at least for increasing the efficiency of mobility management in wireless communication networks. To improve or enhance access control accuracy and efficiency, the systems and methods discussed herein can include processes, procedures, and/or implementations for signaling.

The second embodiment proposes methods and apparatus related to the UE assistance information report scheme to verify a location of a UE. The proposed methods are beneficial at least for increasing the efficiency of the mobility management for a network node. The systems and methods discussed herein can include processes, procedures, and/or implementations for signaling.

The example embodiments disclosed herein are directed to solving the issues relating to one or more of the problems presented in the prior art, as well as providing additional features that will become readily apparent by reference to the following detailed description when taken in conjunction with the accompanying drawings. In accordance with various embodiments, example systems, methods, devices and computer program products are disclosed herein.

It is understood, however, that these embodiments are presented by way of example and are not limiting, and it will be apparent to those of ordinary skill in the art who read the present document that various modifications to the disclosed embodiments can be made while remaining within the scope of this disclosure.

### Initial Introduction

### NTN Deployment

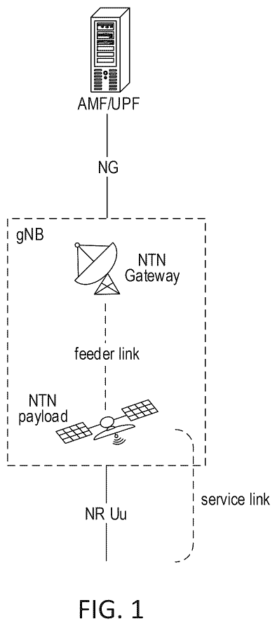

FIG. 1 illustrates an example of a Non-Terrestrial Network (NTN) providing non-terrestrial NR access to the UE by means of an NTN payload and an NTN Gateway, depicting a service link between the NTN payload and a UE and a feeder link between the NTN Gateway and the NTN payload.

The following connectivity is supported by the NTN payload:
An NTN gateway may serve multiple NTN payloads;
An NTN payload may be served by multiple NTN gateways.

Three types of service links are supported:
Earth-fixed: provisioned by beam(s) continuously covering the same geographical areas all the time (e.g., the case of Geosynchronous Orbit (GSO) satellites);
Quasi-Earth-fixed: provisioned by beam(s) covering one geographic area for a limited period and a different geographic area during another period (e.g., the case of Non-Geosynchronous Orbit (NGSO) satellites generating steerable beams);
Earth-moving: provisioned by the beam(s) whose coverage area slides over the Earth's surface (e.g., the case of NGSO satellites generating fixed or non-steerable beams). Here, the beams can be either fixed or non-fixed.

With NGSO satellites, the gNB can provide either a quasi-Earth-fixed service link or an Earth-moving service link, while gNB operating with a GSO satellite can provide an Earth-fixed service link.

### RACH Procedure

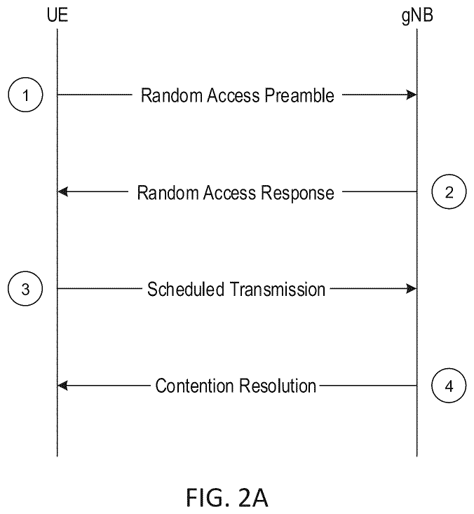

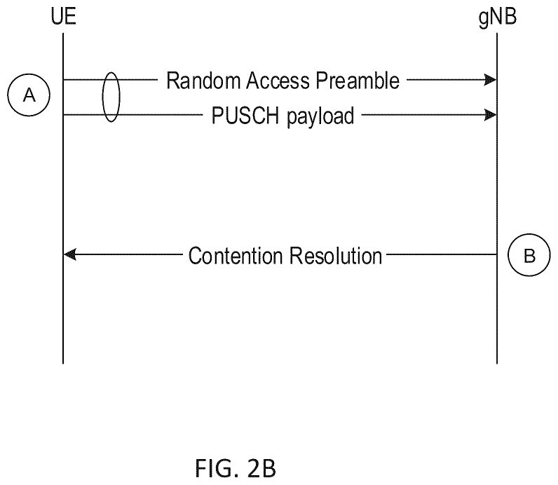

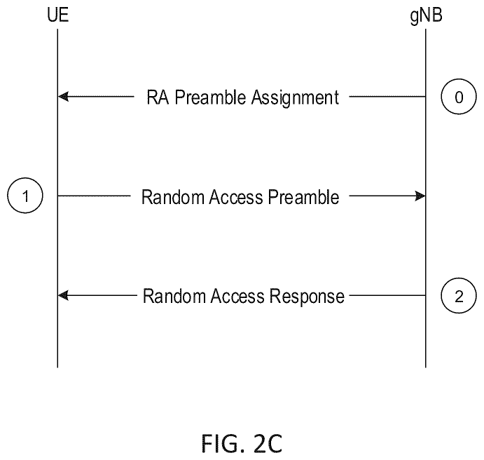

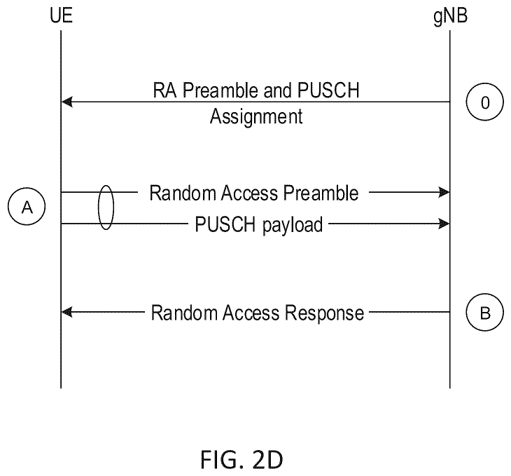

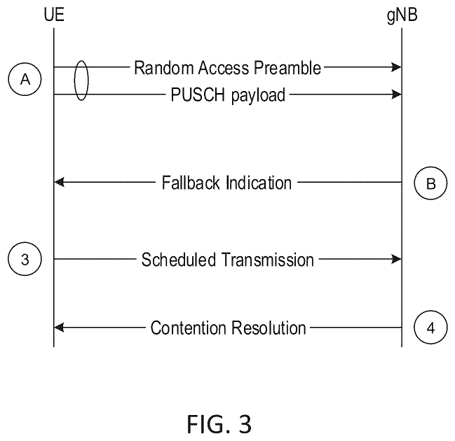

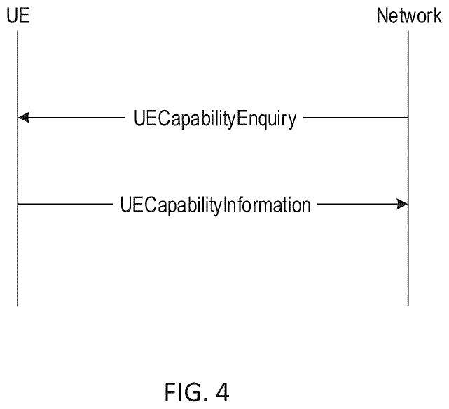

Two types of random-access procedures are supported: 4-step RA type with MSG1 and 2-step RA type with MSGA. Both types of RA procedure support contention-based random access (CBRA) and contention-free random access (CFRA), as shown in FIG. 2A below.

The UE selects the type of random access at the initiation of the random-access procedure based on network configuration:
when CFRA resources are not configured, an RSRP threshold is used by the UE to select between the 2-step RA type and 4-step RA type;
when CFRA resources for the 4-step RA type are configured, UE performs random access with the 4-step RA type;
when CFRA resources for the 2-step RA type are configured, UE performs random access with the 2-step RA type.

The network does not configure CFRA resources for 4-step and 2-step RA types simultaneously for a Bandwidth Part (BWP). CFRA with a 2-step RA type is only supported for handover.

The MSG1 of the 4-step RA type consists of a preamble on the Physical Random Access Channel (PRACH). After MSG1 transmission, the UE monitors for a response from the network within a configured window. For CFRA, a dedicated preamble for MSG1 transmission is assigned by the network. Upon receiving random access response from the network, the UE ends the random access procedure, as shown in FIG. 2C For CBRA, upon reception of the random access response, the UE sends MSG3 using the UL grant scheduled in the response and monitors contention resolution as shown in FIG. 2A. If contention resolution is not successful after MSG3 (re)transmission(s), the UE goes back to MSG1 transmission.

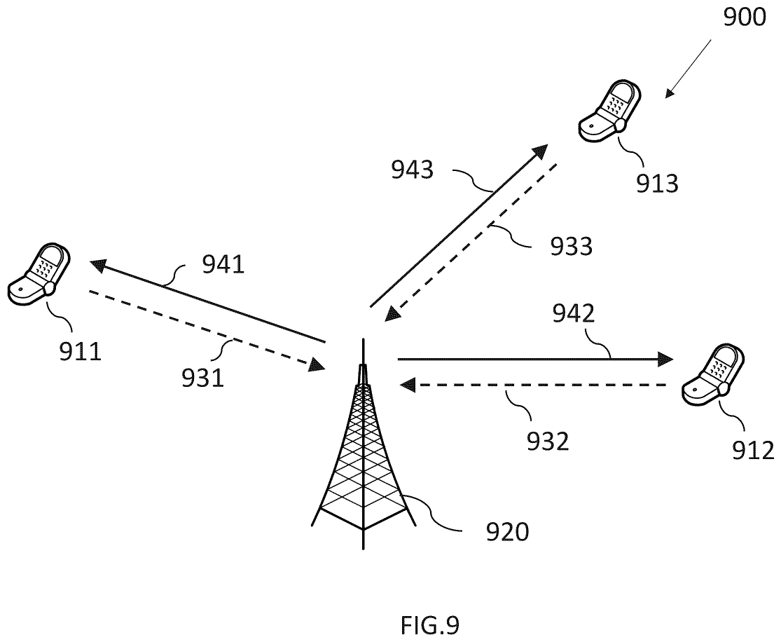

The MSGA of the 2-step RA type includes a preamble on PRACH and a payload on PUSCH. After MSGA transmission, the UE monitors for a response from the network within a configured window. For CFRA, dedicated preamble and PUSCH resources are configured for MSGA transmission, and upon receiving the network response, the UE ends the random access procedure as shown in FIG. 2D. For CBRA, if contention resolution is successful upon receiving the network response, the UE ends the random access procedure as shown in FIG. 9.2.6-1(b); while if a fallback indication is received in MSGB, the UE performs MSG3 transmission using the UL grant scheduled in the fallback indication and monitors contention resolution as shown in FIG. 2B. If contention resolution is not successful after MSG3 (re)transmission(s), the UE goes back to MSGA transmission.

If the random-access procedure with a 2-step RA type is not completed after a number of MSGA transmissions, the UE can be configured to switch to CBRA with a 4-step RA type.

### Embodiment 1

### General:

Step 1: UE receives and stores the (conditional) handover configuration from NW, which includes the RACH configuration

Step 2: UE get access to the target cell according to the configuration stored, including initiating RACH to obtain uplink synchronization

In the RACH procedure, UE selected RACH resources, including time and frequency domain resources as well as code domain resources. At least one of the three domain resources is different and can guarantee that NW can distinguish the RACH request received from UEs, thus avoiding contention. Below options can be considered to mitigate the RACH contention.

### Option 1: Based on Time Domain Dispersion:

For step 1, the configuration can include at least one of the below information to mitigate the RACH contention issues: a timing offset parameter can be included in the configuration, which indicates a maximum delay time for UE to delay the initiation of RACH procedure to target. Multiple options can be used for UE to determine the timing offset value received.

In one example, the timing offset can be a duration of time, which indicates the maximum time for UE to delay the initiation of the RACH procedure to the target cell.

In another example, the timing offset can be an index where each index refers to a time duration. The time duration is the maximum time for UE to delay the initiation of the RACH procedure to the target cell.

In some examples, the above configuration used to mitigate RACH contention issues can be included as part of the RACH configuration. For some examples, in step 1 the configuration received can include other parameters, e.g., the cell-specific and/or UE-specific parameters as specified in 3GPP specs 38.331.

Though in example explanation RACH procedure is mentioned as the procedure where the timing offset can be used to mitigate the contention. The usage of timing offset discussed can be used to resolve contention issue occurs for other uplink (UL) transmission types, e.g., UL transmission using configured grant resource, or UL transmission scheduled by downlink control information (DCI) and etc.

For step 1, the received configuration can be delivered to UE according to one or multiple methods as shown below: 1) System information, 2) Radio Resource Control (RRC) message (e.g., RRCReconfiguration), 3) Non-access Stratum (NAS) message 4) Medium Access Control Control Element (MAC CE) 5) Group cast or multicast message, for example, a common RNTI (or group RNTI) can be assigned to UE. UE will use this assigned common RNTI to monitor and receives downlink control information used to schedule the message including the configuration, or 6) Paging message.

Also a combination of the above methods given can also be used. For example, part of the configuration (e.g., cell-specific configuration that is common to all UE) can be assigned to UE via a common signalling (e.g., via system information or groupcast message or multicast message) while UE can receive UE specific configuration (e.g., C-RNTI) via dedicated RRC signalling. In another example, UE can receive the configuration via common signalling (e.g., via syste information or groupcast or multicast), and NW can update/modify or release the received configuration based on dedicated RRC signalling.

All the above methods can also be used to add, modify or release the received configuration.

### For Step 2: Deciding the Applicability of Received Timing Offset

Below options can be used for UE to determine whether the timing offset parameter received in the step 1 is applicable or not. When determining timing offset parameters is applicable, UE applies the timing offset when initiating RACH according to examples discussed in the below section. Otherwise (i.e., if the timing offset is considered as not applicable), UE will initiate RACH based on timing specified in specs (i.e., without considering the timing offset discussed in step 1)

In one example, the presence of a timing offset parameter can be used to indicate that the timing offset is applicable.

In another example, one indication can be used to indicate whether the timing offset parameter received is applicable or not. In yet another example, a one-bit indication can be used. e.g., value 1 indicates the timing offset parameter received is applicable, while zero means it is not applicable. Or vice versa.

In another example, an indication with an enumerated type can be used. E.g., the presence of this indication with true value indicates the timing offset parameter received is applicable while absence means the timing offset is not applicable.

In another example, an indication is used to disable the usage of the timing offset value. For example, one example is to use this disabling indication together with example 1. e.g., UE always uses the received timing offset parameter is applicable. But if it receives the disabling indication, UE considers this timing offset as not applicable.

In yet another example, NW type can be used to decides the applicability of timing offset parameter. For example, when deciding the NW type is NTN, UE considers the timing offset is applicable. Otherwise, UE considers the timing offset is not applicable. The NW type can be NTN or TN, or Radio Access Technology (RAT) type (e.g., 4G, 5G and 6G), or any type of communication system used.

The information used for UE to decide whether the timing offset can be included in one or more methods as shown below:
In system information, e.g., MIB or SIBx;
In RRC message, e.g., RRCReconfiguration message. In some examples it can be included in otherConfig or in TAR-Config.
In NAS message
In MAC CE
In paging message;
In group cast signalling, e.g., a message scrambled by a common RNTI can inform UE with the information.

### For Step 2: Determine the Timing to Initiate RACH

Below steps are used for UE to decide the value of the timing offset used and performs the RACH procedure accordingly as part of the conditional (HO) procedure.

Step 1: When UE decides the timing offset applies to this (conditional) HO, UE randomly generates a value between [0, timing offset received], and UE determines the timing offset value equals the generated value.

Step 2: UE performs RACH resource selection after the timing offset time and transmits the first message of the RACH procedure according to the resource selected. The RACH procedure can be 2-step RACH, 4-step RACH or another RACH specified.

Below are examples of how the timing offset will be used in the RACH procedure:

In some examples, the timing offset is only applicable for the first RACH attempt associated to this HO procedure. This means for this HO procedure, UE will only this timing offset to delay the initiation of the RACH procedure once and only for the first RACH resource.

In one example, step 1 happens only once at the initialization of the RACH procedure, and a variable can be used to store the timing offset value generated. After performing the first RACH selection, the variable will be reset to zero.

In some examples, the timing offset applies to each attempt of the RACH procedure until the handover fails (e.g., T304 expires).

In one example, step 1 happens at the initialization of the RACH procedure, and a variable can be used to store the timing offset value generated. UE delay timing offset time for each RACH resource selection.

In one example, step 1 happens right before the RACH resource selection. For example, UE generates timing offset time each time it performs RACH resource selection.

In some examples, the timing offset is only applicable for the first transmission of first message of RACH of the same type. In one example, step 1 happens at initialization of the RACH procedure at most once for each RA type. For example, 2step RA is selected first, UE generates a timing offset and uses it for the first MsgA transmission, during the RACH procedure, RA type is switched to 4 step RA type, UE then generates a new timing offset and use it for the first Msg1 transmission (e.g., preamble) of 4step RA type. In some examples, a variable can be used to assist this behavior, e.g., the variable is set the UE-generated timing offset in the initiation of variables for a selected RACH type and reset to zero after the first RACH resource selection of the selected RA type.

### For Step 1: Capability Signaling

Example 1: Using timing offset can be an optional feature for UE. This feature can be optional without signaling. If UE doesn't support this feature, it can simply ignore the timing offset received.

Example 2: Using timing offset can be an optional feature for UE. One capability is used to indicate whether UE supports this feature.

The capability bit can be transferred in UE capability signaling as specified in 3gpp specification 38.331 and 3GPP specs 38.306. One example is as below:

Example 3: The usage of timing offset can be conditional optional for UE, which means support of this feature could be dependent on some conditions specified. For example, UE supports this feature if UE supports group-based (conditional) HO. For example, UE supports this feature if UE supports NTN. For example, UE supports this feature if UE supports receiving (conditional) HO configuration in system information.

Example 4: UE mandatory supports this feature.

Below is an example of how to enquire about UE to report UE capability information to NW.

NW can send a first message to enquiry about UE's capability, and UE can send a capability information to inform NW about its capability. In some examples, NW can use the capability received to decide whether to configure the timing offset parameters to UEs. In another example, NW can transfer the UE capability information received between different NW nodes. Or in some examples, if UE doesn't support this feature, UE can ignore the timing offset parameters configured.

### Option 2: Based on Code Domain Differentiation:

### For Step 2: New Preamble Format Can be Used

Code domain differentiation can be done by introducing a new preamble format, which can be done by one or more of the below options:

A UE identity can be used to scramble the preamble sent to NW.

In one example, C-RNTI included in the received (conditional) HO configuration can be used. In another example, only part of the C-RNTI is used (e.g., the leftmost X bits or rightmost Y bits).

In another example, the security key included in the received (conditional) HO configuration can be used. In another example, only part of the security is used (e.g., the leftmost X bits or rightmost Y bits).

Since this information is known at both NW and UE's sides, then NW can try to detect the preamble based on the scrambling information.

Alternatively, a UE identity can be used to generate a preamble.

In one example, C-RNTI included in the received (conditional) HO configuration can be used. In another example, only part of the C-RNTI is used (e.g., the leftmost X bits or rightmost Y bits).

A combination of the above examples can be used as a new preamble format.

### For Step 2: Deciding the Usage of the New Preamble

Below options can be used for UE to determine whether to use new preamble in RACH or not.

In one example, One indication can be used to indicate whether to use the new preamble format in RACH or not. For example, a one-bit indication can be used. e.g., value 1 indicates to use the new preamble format, while zero means not to use the new format of a preamble. Or vice versa.

In another example, an indication with enumerated type can be used, e.g., the presence of this indication with the value true indicates to use of the new preamble format while absence means not to use it.

In yet another example, an NW type can be used to decide whether to use the new preamble format. For example, when deciding the NW type is NTN, UE decides to use the new preamble format. Otherwise, UE will not use the new preamble format. The NW type can be NTN or TN, or Radio Access Technology (RAT) type (e.g., 4G, 5G and 6G), or any type of communication system or communication technology used.

In yet another example, the HO type can be used to decide whether to use the new preamble format. When parts or the whole of the (conditional) HO configuration is received in common signaling (e.g., in group signaling or in system information or in paging message), UE decides to use the new preamble format. Otherwise, UE will not use the new preamble format.

In yet another example, an indication is used to disable the usage of the new preamble format. For example, UE always uses the new preamble format. But if it receives the disabling indication, UE will not use the new preamble format. This example can be used in combination with the above examples. E.g., One example is to use this disabling indication together with example 4. UE consider the new preamble as the default RACH configuration when the (conditional) HO configuration is received in common signaling. If a disabling indication is not received, UE use the new preamble format discussed above, otherwise, if the disabling indication is received, UE will not use the new preamble format.

### For Step 1: Capability Signaling

The solutions discussed in the above section for signaling UE's capability to support the timing offset feature can also be considered for signaling UE's capability to support of this new preamble format.

Option 1 and option 2 can be used independently or in combination with each other.

### Embodiment 2: UE Assistance Information Report for NW to Verify UE Location

Timing advance is considered as equivalent information for UE to calculate the Round Trip Time (RTT) between UE and NW, which can be further used to estimate UE location. In one example, assuming multiple TA information can be received within a measurement period, NW can be based on the TA information to derive the propagation delays between UE and NW at different time instances. NW can draw a circle for each derived propagation delay, and the intersection of the drawn circles will be the possible range UE locates. The accuracy will depend on the frequency of TA reports and TA report granularity. Another method is to report the RTT instead of the TA, which can achieve the same purpose.

### General:

The below steps can be used to configure UE to report assistance information to help NW verify UE location. The step that NW receives UE reported location is not illustrated. It can be provided together or independently from below steps discussed.
Step 1: NW provides configuration for multi-XXX report
Step 2: NW receives a multi-XXX report from UE
Step 3: NW derive UE location based on the TA information received
Step 4: NW determines whether UE reported location information is trustful or not

NW can be one or more of the following:
A core network (CN) or one or more entity hosting functions of CN, e.g., Location management function (LMF) or Access Management Function (AMF).
NG-RAN nodes, or one or more entities hosting functions of NG-RAN nodes, e.g., OAM. The NG-RAN nodes can be gNB, ng-gNB or other bases station specified in 3GPP specification or any composition of a base station.

In some examples, if XXX could be RTT, and UE report content is RTT relevant information. In another example, the report content can be TA-relevant information. In this case, XXX could be TA. However, all this is only a reference. The exact terminology used could still be different. Please note that the multi-XXX report here is only an example terminology. Other terminology can also be considered for the report discussed here.

### For Step 1:

### Issue 1: Which Nodes Generate the Multi-XXX Report Configuration

The configuration can come from at least one of the below NW nodes:

Case 1: The configuration is generated by CN.

Case 2: The configuration generated by NG-RAN nodes (e.g., gNB).

Case 3: Combination of case 1 and case 2.

Example 1: CN generates and delivers the configuration to gNB. GNB can modify or update or release the configuration received and deliver to UE

For case 1, when multi-TA report configuration comes from CN, the configuration can be either transparent to NG-RAN nodes or be known to NG-RAN nodes. When a multi-TA report is transparent, NG-RAN nodes only forward the received message, including the configuration of NW-verified UE location to UE. When the multi-TA report is known to NG-RAN nodes, in some examples, NG-RAN nodes can decide whether to update the configuration when configuring UE with the configuration in step 2.

### Issue 2: The Content of the Multi-XXX Report Configuration

The configuration includes at least one of below:

Report intervals, which specify the periodicity for UE to perform reporting

Measurement interval, which specifies the periodicity for UE to perform measurements. In some examples, the report interval can also be used for performing measurements or vice versa.

Report amount, which specifies the number of reports to be reported

Report duration, which specifies the duration for UE to perform reporting

Measurement duration, which specifies the duration for UE to perform measurements. In some examples, the report duration can also be used for measurements or vice versa

Activation indication, which indicates NW or UE to start measuring and/or reporting for the purpose of NW-based UE location verification upon reception of this indication

Purpose indication or type indication, which indicates the purpose or the type of this configuration/task, is for NW-based UE location verification.

Report content indication, which indicates the content of information to be reported. In one example, the indication can have the value as the name of the content to be reported. e.g., when report content indicates value as ‘TA’, UE reports TA information. If report content indicates value as ‘RTT’, UE reports RTT information. In another example, the indication can indicate an index, where each index refers to one type of content to be reported.

Threshold, which is used to trigger the report. For example, if the difference between current measurements and lasted reported measurements is equal to or larger than the threshold, UE initiate the report procedure

An indication, which indicates whether scheduling request procedure can be used for requesting UL resource for this report

### Issue 3: The Method to Deliver Configuration of Multi-XXX Report to UE

The configuration from one or multiple of the below options:

Option 1: By DL NAS message, e.g., DLInformationTransfer.

Option 2: By DL RRC messages. E.g., RRCReconfiguration, RRCResume or RRCSetup messages. It can be included in differentb places within RRC messages, e.g., in measurement objectives (e.g., measObjectNR) or in otherConfig or in TAR-Config.

Option 3: By System information. One example would be in SIB19.

Option 4: By paging the message.

Option 5: By common message defined for group cast or multicast.

Option 6: A combination of the above options can also be considered. For example, the configuration can be provided in SIB19 and be modified/released by DL RRC signaling.

The above options can also be considered for updating, adding, modifying, or releasing the configuration.

### Issue 5: How to Active the NW Verified UE Location Task

Option 1: Upon reception of the message, including the corresponding configuration, UE starts TA measurement and reports upon reception of this configuration.

Option 2: Based on the activation indication received

For option 2, UE stores the received configuration and waits until activation command is received from NW to start the measurements and report. Below are examples of how the activation indication can be delivered:

Example 1: As discussed above, the activation indication can be carried in the same message that carries the configuration for NW verified UE location.

Example 2: In another example, it can be carried in MAC CE.

Example 3: It can be carried in a message used to activate the NW-verified UE location information task (e.g., NW-verified location activate message), which can be a NAS message or RRC message.

Example 4: It can be a one-bit indication included in system information, in paging or in RRC messages.

### Issue 6: Configuration Release

The below options can be considered to release the configuration received

Option 1: UE release the configuration upon reception of the release message from NW

Option 2: UE releases the configuration after completion of transmission of the message, including the reports.

Option 3: UE releases the configuration after receiving an explicit indication from NW. The solution discussed above for activation indication can also be used to deliver the release indication to UE.

Option 4: UE releases the configuration after a certain amount of time. The time can be

### Issue 7: Capability Signaling and Transfer

In one example, This feature can be optional supported. one capability bit can be used to indicate whether UE supports provide assistance information to NW for NW-verified UE location purposes. The indication can be transferred in one or multiple of the below options:
Capability message used to deliver capability relevant to positioning function. For example, LPP provide capabilities
UE Capability enquiry procedure as specified in 3GPP 38.331 specs

In another example, this feature can be conditionally supported. For example, if UE supports NTN, UE supports this feature.

In another example, this feature is mandatory and supported

For the above-mentioned options for capability signaling, it is possible for NW to transfer the UE capability information among different RAN nodes.

### For Step 2:

### Issue 1: Report Content or, in Another Word, Assistance Information

The content of reports can be at least one of below:

Option 1: UE specific TA. In one example it could be the Timing Advance Report as specified in 3GPP specs 38.321. In one example, the UE specific TA refers to the the sum of service link delay and feeder link delay.

Option 2: Differential UE-specific TA. The UE specific TA can be TA discussed in above option 1.

Option 2-1: The first measurement is UE-specific TA, and the follow-up TA is the TA difference compared with the first TA reported/measured.

Option 2-2: The first measurement is UE-specific TA, and the follow-up TA is the TA difference compared with the last TA reported/measured.

Option 3: Service link delay estimated by UE.

Option 4: Differential service link delay estimated by UE.

Option 2-1: The first measurement is the service link delay UE estimates, and the follow-up measurements is the delay difference compared with the first service link delay reported/measured.

Option 2-2: The first measurement is the service link delay UE estimates, and the follow-up measurement is the delay difference compared with the last measured/reported service link delay.

Option 5: UE-gNB RTT as specified in 3GPP specs 38.331.

When the differential value is reported, it is possible to report a negative value if the latest TA or RTT or service link delay decreases. To help NW knows about this situation below options can be considered.

One bit is reserved to indicate whether the reported value is positive or negative. For example, zero means positive, while 1 means negative or vice versa. The one-bit can be placed in the leftmost or in the rightmost position. Or another location can be reserved for this bit.

The granularity of above reported TA or RTT or service link delay can be at least one of below options:

Option 1: In the number of slots assuming SubCarrier Spacing (SCS) equals to certain frequency. For example, the SCS could be a fixed value, e.g., 15 KHz. In another example, the SCS could be the SCS of the PUSCH resource used to transmits the report.

Option 2: In the number of nanoseconds or tens of nanoseconds.

Option 3: In the number of milliseconds.

Option 4: In the number of microseconds

Option 5: In the number of symbols.

Option 6: In the number of SFNs.

Option 7: If the timing advance report is enhanced to provide assisting information for NW verified UE location. Then different granularity can be defined for TA reports for different purposes, which can be configurable by NW. And below alternatives can be considered:

Alt1: The granularity is explicitly configured by NW by at least one or more methods mentioned here: NAS signalling or RRC signalling or system information or MAC CE signalling or Groupcast/multicast or paging.

Alt2: A default granularity is used unless another is configured.

### Issue 2: Which Message to be Used to Receive the Reports

Option 1: MAC CE

Option 2: UL RRC messages. Below are some examples that can be considered for delivering the reports:
In measurement reports
In UEInformationResponse
In UE assistance information
In RRCResumComplete message
In RRCReconfigurationComplete message
In RRCSetupComplete message or
new defined RRC message

Other RRC message as defined in specs can also be considered, e.g., RRCResumeRequest message

Option 3: UL NAS messages. Below examples can be considered for deliver the reports:
ULInformationTransfer
UEPositioningAssistanceInfo or
new defined NAS message

Other NAS messages, as defined in the specs can also be considered

If the Timing advance report is enhanced to provide assisting information for NW verified UE location, then the method needs to be considered to allow NW to know the unit of TA reported. One option is to modify the reserved bit of Timing Advance Report MAC CE to indicate which granularity is used as the unit of Timing Advance value indicated by the Timing Advance field in Timing Advance Report MAC CE. For example, a granularity bit ‘G’ can be introduced. If G is set to zero means the unit defined in release 17 for Timing Advance Report MAC CE (e.g. in the number of slots using subcarrierSpacing of 15 kHz) is used, while G is set to 1 means new granularity (e.g., finer granularity) defined for NW verified UE location purpose is used. An example is given in below figure:

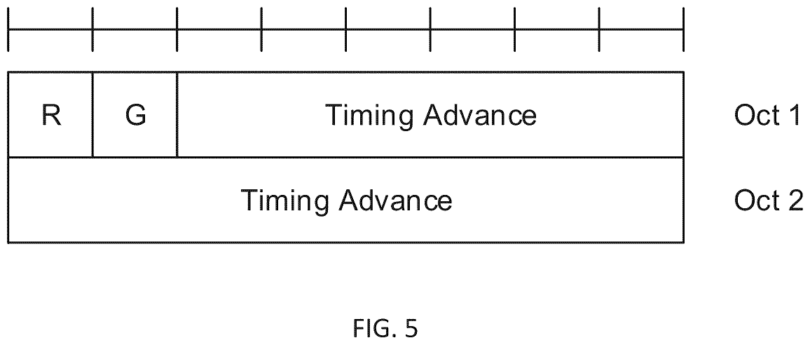

The Timing Advance Report MAC CE is identified by the MAC subheader with LCID. It has a fixed size and consists of two octets defined as follows, as shown in FIG. 5.
R: Reserved bit, set to 0;
G: granularity bit, which is to indicate which granularity is used for the timing advance field.
Timing Advance: In FR1, if G is set to zero, the Timing Advance field indicates the least integer number of slots, using subcarrier spacing of 15 kHz, greater than or equal to the Timing Advance value (see TS 38.211 [8], clause 4.3.1). If G is set to 1, the timing advance field indicates the Timing advance value in the units of microseconds. The length of the field is 14 bits.

Here, the disclosed example given above is only for explanation purpose, the location of the indication can be different, the terminology used can be different. Also the example units in the explanation field could also be different.

### For Step 3:

### Issue 1: Which Nodes Can Derive UE Location

At least one of the below NW nodes can derive the UE location based on the assistance information received

Case 1: CN or entity hosting one or more functions of CN (e.g., LMF) receives the assistance information and derives UE location

Case 2: NG-RAN nodes (e.g., gNB) or entity hosting one or more function of NG-RAN nodes, e.g., OAM receives the assistance information and derive UE location

Case 3: Both entities mentioned in case 1 and case 2 can independently compute UE location based on the received assistance information.

### For Step 4:

### Issue 1: Which Nodes Can do the Verification

At least one of the below NW nodes can derive the UE location based on the assistance information received

Case 1: Only CN or entity hosting one or more functions of CN (e.g., LMF) can do the verification

Case 2: The entity that receives the assistance information and derives location information can do the verification

For case 1, if the UE location is derived in a node other than CN, or entity hosting CN functions (e.g., LMF). Then the node needs to deliver at least the UE location derived to CN. Additional information can also be provided, e.g., the assistance information used for calculation and/or the method used for calculation.

For case 2, it is possible that more than one entity can do the verification, then CN can request another entity to provide one of the below for double verification:
Verification outcome, which can include one or more content as discussed in the below section
Assistance information used for calculation

The method used for the calculation of UE location

### Issue 2: Verification Outcome Content

The verification outcome can include at least one of below:
A flag indicates whether UE reported location is correct or not;
A flag indicates whether UE is trustful for location reports;
A flag indicates whether UE is allowed to access to the NW
Duration indicates how long UE is considered as untrustful;
Duration indicates how long UE is considered as trustful;
An area where UE is considered as untrustful or is not allowed to access to NW;
An area where UE is considered as trustful or is allowed to access to NW;
UE identity is used to uniquely identify the UE within the NW;
Assistance information used for calculation;
The method used for calculating UE location;
UE reported location;
NW estimated UE location;
Confidence interval, which indicates the confidence level of the estimated results
Estimate error, which indicates the error range of the estimated results

In some examples, if NW determines that the UE has reported a fake location, then the below one or more actions can be considered by NW.

Release the UE's connection:
One purpose indication can be used to indicate the release purpose. For example, the indication is used to indicate that the UE is released due to not passing the NW-based UE location verification task.
The message used to release the UE connection can also include one or more content discussed above in the verification outcome content section.

Reject the UE's request to connect to the NW for a certain period of time. The time can be indicated as the verification outcome or included in the message used to release the UE connection.

Reject the UE's request to connect to the NW for a certain area. The area can be indicated as part of the verification outcome or included in the message used to release the UE connection

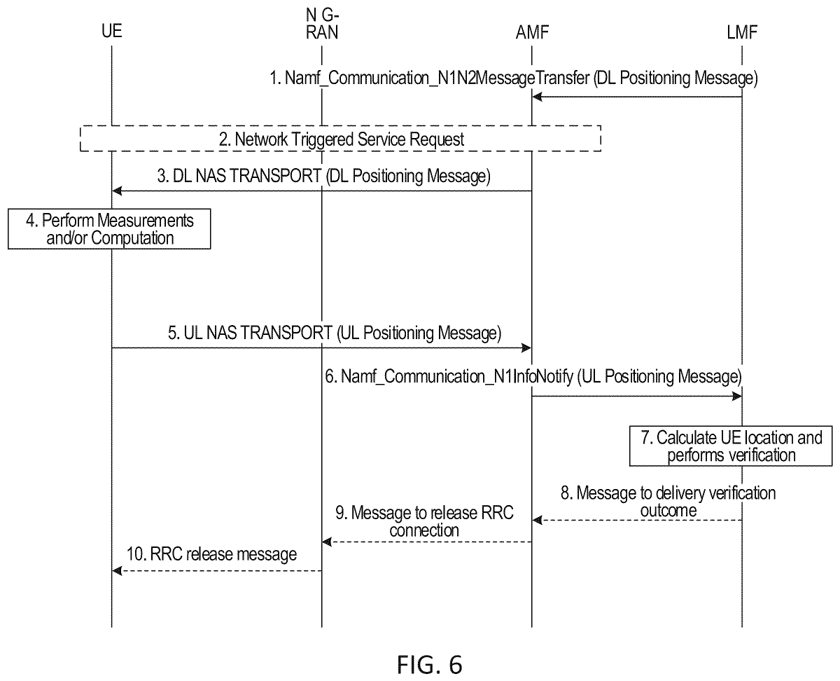

FIG. 6 gives an example on the signaling flowchart for NW verified UE location task.

In step 1, LMF triggers the NW verified UE location task by sending multi-XXX report configuration to AMF. Step 2, as shown in example FIG. 6, is optional. e.g., when UE is in an idle or inactive state, paging is needed to transit UE to the connected mode for data transmission. In step 3, AMF deliver the received configuration to UE by NAS message. In this example, the configuration is included in the DL positioning message.

Step 4. After receiving the configuration, UE perform measurements and calculation accordingly. And report the measurement results in UL NAS message to AMF in step 5. In this example, UE-reported assistance information is included in the UL positioning message. AMF forward the received measurements to LMF in step 6. After receiving the measurements, LMF calculate UE location and performs verification.

Steps 8-10, as shown in FIG. 6, are also optional. For example, LMF decides to inform AMF if the verification outcome indicates UE has reported a fake location. After receiving such information, AMF can choose to release the UE connection as illustrated in steps 9 and 10.

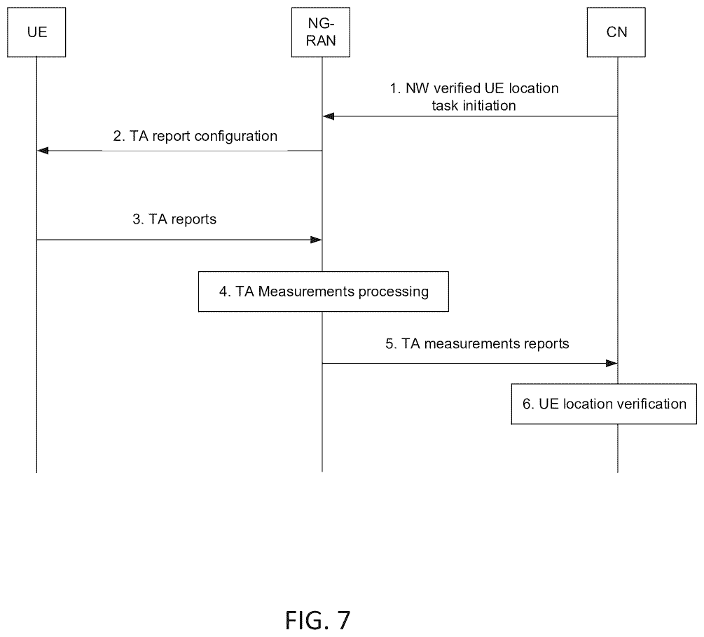

Below, as shown in FIG. 7, is another example assuming TA is the assistance information used for NW to verify UE location. The assistance information can be other parameters specified in specs or discussed in this disclosure.

Step 1: CN triggers NW verified UE location task and informs NG-RAN;

Step 2: After receiving the message used to trigger the NW verified UE location task, NG-RAN configures UE with TA report configuration (e.g., in TAR-Config)

Step 3: UE performs TA measurements and reports to NG-RAN accordingly

Step 4: NG-RAN processes the received TA measurements (e.g., subtracting feederlink delay) and transmits the results to CN

Step 5: CN based on received TA measurements to perform verification

### Embodiment 3: Methods to Provide Information with Suitable Granularity for TN Coverage Estimation

In this embodiment, methods to provide UE with information to determine an granularity for TN coverage calculations are discussed. At least one of the below options can be considered for UE to determine the granularity used for TN coverage estimation based on information provided by NW:

Option 1: A fixed granularity can be defined. For example, the fixed granularity can be cell level, e.g., TN coverage is counted as a number of cells. Other granularity can also be considered, e.g., coverage level similar to tracking area, coverage level similar to RAN notification area, and so on. Or in some examples, if a geometric shape identifies an area, then a fixed units for the caculation of the geometric shape can be considered as the granularity used for presenting the TN coverage. For example, if the TN coverage is indicated by a circular area presenting by a cell center and a radius, then granularity can be presented as x km of radius, then the TN coverage in this example is of x's square of square kilometres (x refers to a mathematical number). However, other units or granularity can also be considered.

Option 2: A configurable granularity may be used. For example, NW can provide UE with a granularity for UE to calculate the TN coverage. For this option, the granularity can refer to the granularity examples discussed in option 1. At least one of the below alternatives can be considered for configuring UE with the granularity:

Alternative 1: A granularity is provided explicitly when proving assisting information for TN coverage calculation.

Alternative 2: A granularity level is provided, where each granularity level correspondent to a specific granularity. The granularity can be either increased or decreased with the increment of granularity levels. For example, granularity level 1 is to use km as unit, level 2 is to use 5 times x km as a unit, level 3 is to use 10 times x km as a unit and so on, here, x refers to a mathematical number. The mapping between granularity levels and granularity to be used can be predefined in specs or configured by NW. The granularity level can be indicated by an index, or a mathematical value.

Alternative 3: A scaling factor can be provided, which is used to scale up or scale down the granularity used for calculating the TN coverage. In one example, UE determines the granularity used by multiplying a default granularity by the scaling factor configured. In some examples, the granularity to be multiplied with could be a current used granularity, a NW configured granularity. The scaling factor can be mathematical values lager than, or equal to, or smaller than 1.

Option 3: Different granularity could be used for different NTN deployment. In one example, the NTN deployment can be GEO, LEO, or HAPS. Or the NTN deployment could be an earth-moving system, GSO system or quasi-fixed system. For example, UE based on NTN deployment to decide which granularity is used to compute the TN coverage. Or in another example, NW configures different granularity for different NTN deployments. Or in another example, NW configures different granularity for different NW types. Or granularity for a specific NW type is defined in specs, and UE based on NW types to decide which granularity is used for calculating TN coverage. For this option, the granularity can refer to the granularity examples discussed in option 1.

Option 4: A minimum granularity can be defined, e.g., a radius of 2 km is used. NW can provide a TN coverage that is equal or larger to this granularity. The minimum granularity can be determined based on methods discussed in option 1 and option 2. In one example, the NTN deployment can be GEO, LEO, or HAPS. Or the NTN deployment could be an earth-moving system, GSO system or quasi-fixed system. In another example, different minimum granularity can be provided for different NW types.

The information discussed in the above options can be provided to UE with one or more methods, as shown below:
In system information, e.g., MIB or SIBx (e.g., SIB19);
In RRC message, e.g., RRCReconfiguration message. In some example it can be included in otherConfig or in measurement configuration (e.g., measObjectNR);
In NAS message;
In paging message;
In group-cast or multi-cast signalling. E.g., a message scrambled by a common RNTI can be used to inform UE with the information.
In MAC CE signalling
   After receiving the information indicating the granularity used for calculating the TN coverage, UE will use the indicated granularity to estimate the TN coverage.

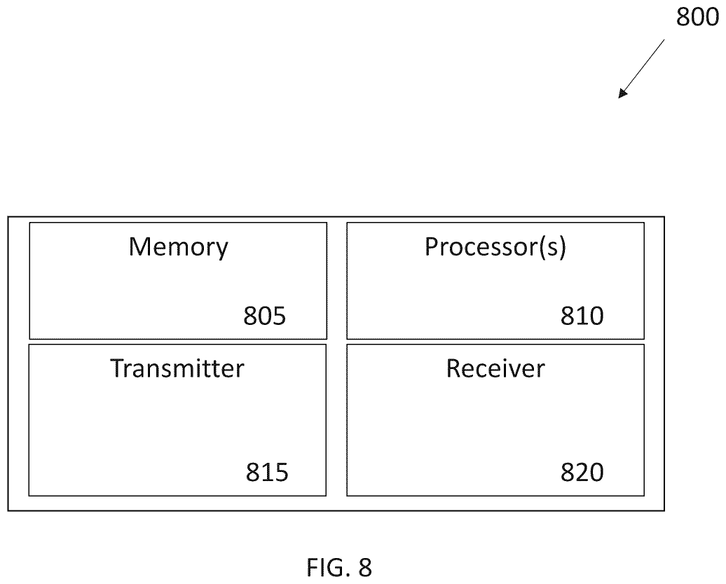

FIG. 8 shows an exemplary block diagram of a hardware platform 800 that may be a part of a network device (e.g., base station BS) or a communication device (e.g., user equipment (UE)). The hardware platform 800 includes at least one processor 810 and a memory 805, having instructions stored thereupon. The instructions upon execution by the processor 810 configure the hardware platform 800 to perform the operations described in FIG. 8 and in the various embodiments described in this patent application document. The transmitter 815 transmits or sends information or data to another device. For example, a network device transmitter can send a message to user equipment. The receiver 820 receives information or data transmitted or sent by another device. For example, user equipment can receive a message from a network device.

The implementations as discussed above will apply to a network communication. FIG. 9 shows an example of a communication system (e.g., a 6G or NR cellular network) that includes a base station 920 and one or more user equipment (UE) 911, 912 and 913. In some embodiments, the UEs access the BS (e.g., the network) using a communication link to the network (sometimes called uplink direction, as depicted by dashed arrows 931, 932, 933), which then enables subsequent communication (e.g., shown in the direction from the network to the UEs, sometimes called downlink direction, shown by arrows 941, 942, 943) from the BS to the UEs. In some embodiments, the BS send information to the UEs (sometimes called downlink direction, as depicted by arrows 941, 942, 943), which then enables subsequent communication (e.g., shown in the direction from the UEs to the BS, sometimes called uplink direction, shown by dashed arrows 931, 932, 933) from the UEs to the BS. The UE may be, for example, a smartphone, a tablet, a mobile computer, a machine to machine (M2M) device, an Internet of Things (IoT) device, and so on.

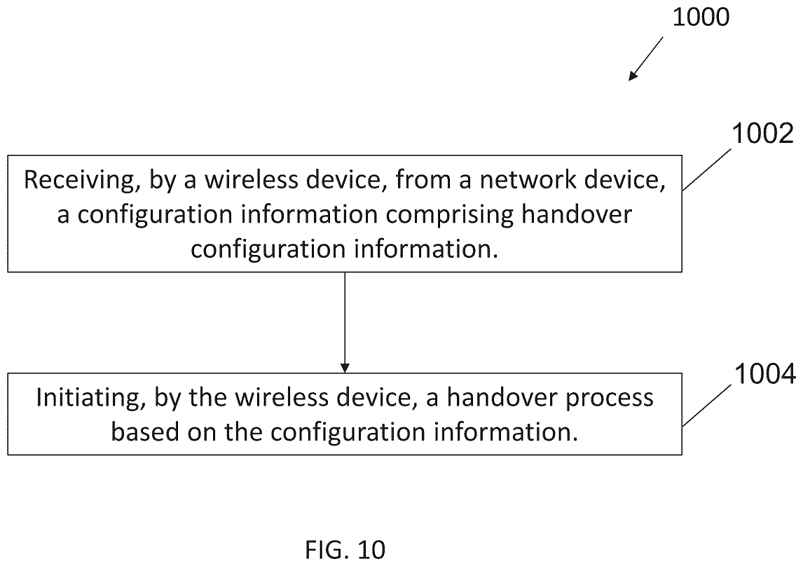

In one example aspect (e.g., as depicted in FIG. 10), a wireless communication method is disclosed. The method includes receiving (1002), by a wireless device, from a network device, a configuration information comprising handover configuration information; and initiating (1004), by the wireless device, a handover process based on the configuration information.

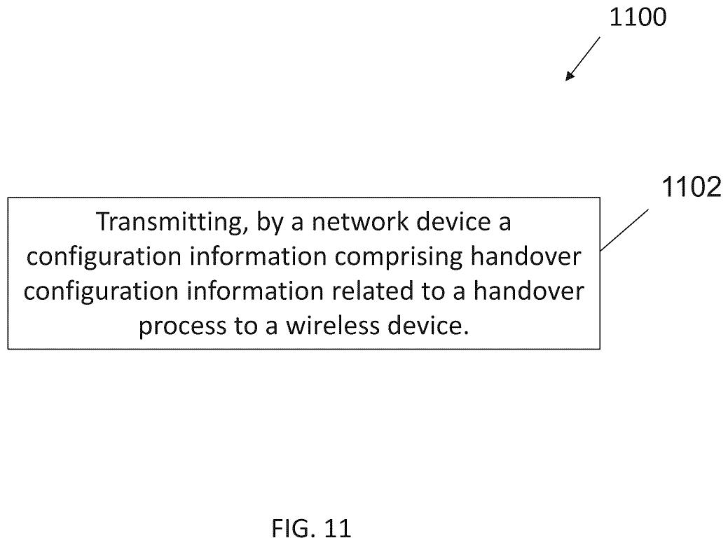

In another example aspect (e.g., as depicted in FIG. 11), another wireless communication method is disclosed. The method includes transmitting (1102), by a network device a configuration information comprising handover configuration information related to a handover process to a wireless device.

In some embodiments, the configuration information comprises a time offset parameter that indicates a maximum time delay for the wireless device to start a transmission of a message.

In some embodiments, the configuration is transmitted in at least one of: 1) a system information, 2) a dedicated signaling, 3) a group cast or multi-cast, or 4) a paging message.

In some embodiments, the above disclosed methods further comprising: determining, by the wireless device, whether the time offset parameter is applicable based on an indication; applying the time offset parameter in initiating the transmission of the message when determining the time offset parameter is applicable; and refraining from using the time offset parameter in initiating the transmission of the message when determining the time offset parameter is not applicable.

In some embodiments, the indication is at least one of 1) a presence of the time offset parameter, 2) an integer type indication indicating the time offset is applicable, 3) an enumerate-type indication, or 5) a network type.

In some embodiments, the indication showing the time offset parameter is disabled.

In some embodiments, the indication is transmitted in at least one of: 1) a system information, 2) a NAS message,3) a RRC message 4) a MAC CE 5) a group cast or multi-cast message, or 6) a paging message.

In some embodiments, the message could be a first message of a RACH process, which comprises at least one RACH attempts, wherein each RACH attempt requires an initial step to initiate the RACH attempt.

In some embodiments, initiating comprises generating, by the wireless device, a value between 0 and the time offset parameter, and initiating the RACH process after a time duration equals to the value.

In some embodiments, the value is generated based on a random method.

In some embodiments, each RACH attempt requires a new value.

In some embodiments, each RACH attempt requires a same value.

In some embodiments, a RACH attempt requires a new value when the wireless device determines a change of RACH process type.

In some embodiments, the above disclosed methods further comprising determining, by the wireless device, whether to apply the time offset to determine the timing of initiating the transmission of message based on a capability of the wireless device.

In some embodiments, the above disclosed methods further comprising: determining, by the network device, whether to include the time offset in the configuration information of the handover information based on a capability of the wireless device.

Various preferred embodiments and additional features of the above-described method of FIGS. 8-9. Further examples are described with reference to embodiments 1 to 3.

It will be appreciated that the present document discloses methods and apparatus related to mobility management and access control in a wireless communication system. The application proposes two embodiments. The first embodiment proposes methods and apparatus related to configuration information transmitted to UE to introduce a randomly generated time delay to increase the success rate of UE's access procedure. The proposed methods are beneficial at least for increasing the efficiency of the mobility management in wireless communication networks. To improve or enhance access control accuracy and efficiency, the systems and methods discussed herein can include processes, procedures, and/or implementations for signaling. The second embodiment proposes methods and apparatus related to UE assistance information report scheme to verify a location of a UE. The proposed methods are beneficial at least for increasing the efficiency of the mobility management for a network node. The systems and methods discussed herein can include processes, procedures, and/or implementations for signaling.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Embodiments are described in detail herein with reference to the accompanied drawings, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Only a few examples and implementations are disclosed. Variations, modifications, and enhancements to the described examples and implementations and other implementations can be made based on what is disclosed.

What is claimed is:

1. A method for wireless communication, comprising:
receiving, by a wireless device, from a network device, a configuration information comprising handover configuration information; and
initiating, by the wireless device, a handover process based on the configuration information.

2. The method of claim 1, wherein the configuration information comprises a time offset parameter that indicates a maximum time delay for the wireless device to start a transmission of a message.

3. The method of claim 1, wherein the configuration is received in at least one of: 1) a system information, 2) a Radio Resource Control (RRC) message, 3) a Non-Access Stratum (NAS message), 4) a MAC Control Element (CE), 5) a group cast or multi-cast, or 6) a paging message.

4. The method of claim 2, further comprising:
determining, by the wireless device, whether the time offset parameter is applicable based on an indication;
applying the time offset parameter in initiating the transmission of the message when determining the time offset parameter is applicable; and
refraining from using the time offset parameter in initiating the transmission of the message when determining the time offset parameter is not applicable.

5. The method of claim 4, wherein the indication is at least one of 1) a presence of the time offset parameter, 2) an indication indicating the time offset is applicable, 3) an enumerated-type indication, or 5) a network type.

6. The method of claim 4, wherein the indication showing the time offset parameter is disabled.

7. The method of claim 4, wherein the indication is transmitted in at least one of: 1) a system information, 2) a dedicated signaling, 3) a group cast or multi-cast, or 4) a paging message.

8. The method of claim 2, wherein the message is a first message of a RACH process, which comprises at least one RACH attempts, wherein each RACH attempt requires an initial step to initiate the RACH attempt.

9. The method of claim 8, wherein initiating comprises generating, by the wireless device, a value between 0 and the time offset parameter, and initiating the RACH process after a time duration equals to the value.

10. The method of claim 9, wherein the value is generated based on a random method.

11. The method of claim 9, wherein a RACH attempt requires a new value when the wireless device determines a change of RACH process type.

12. The method of claim 2, further comprises determining, by the wireless device, whether to apply the time offset to determine the timing of initiating the transmission of message based on a capability of the wireless device.

13. A method for wireless communication, comprising:
transmitting, by a network device a configuration information comprising handover configuration information related to a handover process to a wireless device.

14. The method of claim 13, wherein the configuration information comprises a time offset parameter that indicates a maximum time delay for the wireless device to start a transmission of a message.

15. The method of claim 13, wherein the configuration is transmitted in at least one of: 1) a system information, 2) a Radio Resource Control (RRC) message, 3) a Non-Access Stratum (NAS message), 4) a MAC Control Element (CE), 5) a group cast or multi-cast, or 6) a paging message.

16. The method of claim 14, wherein the message is a first message of a RACH process, which comprises at least one RACH attempts, wherein each RACH attempt requires an initial step to initiate the RACH attempt.

17. The method of claim 13, further comprising:
determining, by the network device, whether to include a time offset in the configuration information of the handover information based on a capability of the wireless device.

18. An apparatus for wireless communication comprising at least one processor configured to implement code from a memory and cause the apparatus to implement a method, comprising:
receiving, by a wireless device, from a network device, a configuration information comprising handover configuration information; and
initiating, by the wireless device, a handover process based on the configuration information.

19. The apparatus of claim 18, wherein the configuration information comprises a time offset parameter that indicates a maximum time delay for the wireless device to start a transmission of a message.

20. An apparatus for wireless communication comprising at least one processor configured to implement code from a memory and cause the apparatus to implement the method recited in claim 13.
